(19) United States
(12) Patent Application Publication
(10) Pub. No.: US 2015/0083503 A1
(43) Pub. Date: Mar. 26, 2015

(54) Weighing Module

(71) Applicant: Naran Naidu, Cullinan (ZA)

(72) Inventor: Naran Naidu, Cullinan (ZA)

(21) Appl. No.: 14/398,556

(22) PCT Filed: Apr. 24, 2013
(86) PCT No.: PCT/ZA2013/000028

§ 371 Date: Nov. 3, 2014

(30) Foreign Application Priority Data
May 4, 2012 (ZA) 2012/03223

(51) Int. Cl. G01G 11/00; G01G 21/23; G01G 3/12

(52) U.S. Cl. CPC G01G 11/003; G01G 3/12; G01G 21/23
USPC 177/210 R

(57) ABSTRACT

The invention provides a weighing module (10) for weighing a load applied to an object. The weighing module is including: at least one first mounting (12) and at least one second mounting (14) being attachable to a primary part of the object; at least one third mounting and at least one fourth mounting being attachable to a secondary part of the object; at least a first bar member (16) having a first end for pivotally mounting to the first mounting and an opposing second end for pivotally mounting to the third mounting; at least a second bar member (18) having a first end for pivotally mounting to the second mounting and an opposing second end for pivotally mounting to the fourth mounting, and one or more load cells (20) attachable between the one or more mountings attachable to the primary part of the object and the one or more mountings attachable to the secondary part of the object.

### BACKGROUND OF THE INVENTION

THIS invention relates to a weighing module. More specifically, the invention relates to a weighing module, which individually or together with other weighing modules, acts as a single idler weighing apparatus for a conveyor belt assembly.

Many types of single idler weighing apparatus are known. Most however, are not accurate in that the weight recording is influenced by dynamic forces associated with conveyor movement.

It is therefore an object of the invention to provide a more accurate single idler weighing apparatus that minimises the effects of dynamic forces associated with conveyor movement, both simply and cost effectively.

### SUMMARY OF THE INVENTION

According to the invention there is provided a weighing module for weighing a load applied to an object, the weighing module including:
at least one first mounting and at least one second mounting being attachable to a primary part of the object such that the first and the second mountings are spaced apart from one another;
at least one third mounting and at least one fourth mounting being attachable to a secondary part of the object such that the third and the fourth mountings are spaced apart from one another;
at least a first bar member having a first end for pivotally mounting to the first mounting and an opposing second end for pivotally mounting to the third mounting;
at least a second bar member having a first end for pivotally mounting to the second mounting and an opposing second end for pivotally mounting to the fourth mounting, each end of the bar members being pivotally mounted on the mounting by a mounting pin passing through correspondingly aligned mounting apertures defined in the respective end of the bar members and the respective mounting so as to retain the first bar and the second bar in a spaced apart and parallel orientation relative to one another; and
one or more load cells attachable between the one or more mountings attachable to the primary part of the object and the one or more mountings attachable to the secondary part of the object
such that in use and under load, the bar members and mountings co-operate with one another to substantially nullify any force component acting in a plane coplanar or substantially parallel to a plane in which the bar members lie, thereby to enable the load cell to measure substantially only a strain caused by the weight of the load on the object.

In a first preferred embodiment, each of the mountings is a fork-like mounting formation for receiving the respective end of the respective bar member, the mounting pin pivotally capturing the end of the bar member within the fork-like mounting formation.

In an alternative embodiment, each of the mountings comprise a male mounting formation and each of the ends of the bar members are fork-like formations for receiving the male mounting formation therein, the mounting pin pivotally capturing the male mounting formation of the mounting within the fork-like mounting formation of the bar members.

The first and second mountings are typically opposing ends of a common primary mounting member, the common primary mounting member being attachable to the primary part of the object. Furthermore, the third and the fourth mountings are generally opposing ends of a common secondary mounting member, the common secondary mounting member being attachable to the secondary part of the object. Preferably, the mounting pins ride on bearings mounted in the mountings, in the ends of the bar members or in both.

The common primary mounting member may be mounted to a primary mounting body and the common secondary mounting member may be mounted to a secondary mounting body, the primary and the secondary mounting bodies being attachable to the primary and secondary parts of the object respectively.

Generally, the primary and the secondary mounting bodies are primary and secondary housings for housing the common primary and secondary mounting members respectively, the primary and the secondary housings being spaced apart from one another by the bar members extending there between, so as to define a gap between the primary and the secondary housings.

Typically, the one or more load cells are connected between the primary and secondary housings across the gap defined there between.

Preferably, the each of the primary and the secondary housings include a base member and a cover member, the base member comprising a base with sidewalls extending outwardly there from, the cover member being engagable with the sidewalls to define, between the base, the sidewalls and the cover member, an inner cavity for housing the common mounting members and respective ends of the bar members mounted thereto.

In a preferred application of the invention, the object is a conveyor belt assembly, the primary part of the object being an idler assembly and the secondary part of the object being a runner structure running between the multiple idler assemblies on the conveyor belt assembly. Preferably, the primary housing is attachable to the primary part of the object and the secondary housing is attachable to the secondary part of the object, the primary and the secondary housings being attachable to the object by fasteners. More preferably, the fasteners are nuts and bolts.

In accordance with a second aspect of the invention, there is provided a weighing apparatus including a pair of weighing modules in accordance with the preceding description thereof, the secondary housings of the weighing modules being connected to each other on opposing ends of a cross member, such that the primary housings of each of the weighing modules are attachable to opposing ends of the idler assembly and the secondary housings of each of the weighing modules are attachable to opposing sides of the runner structure of the conveyor belt assembly.

In accordance with a third aspect of the invention, there is provided an idler assembly for weighing a load passing there over including:
a support bracket for supporting one or more idler mounting sub-brackets on which idlers are supportable;
a pair of weighing modules in accordance with any one of claims 11 to 13, the primary housings of each of the weighing modules being attached to opposing ends of the support bracket; and
a cross member attached at each opposing end to the secondary housings of the weighing apparatus, the secondary housings being attachable to opposing sides of a runner structure of a conveyor belt assembly.

### BRIEF DESCRIPTION OF THE DRAWINGS

The invention will now be described in more detail, by way of example only, with reference to the accompanying drawings in which:

FIG. 1 is a perspective view of a weighing module in accordance with the present invention;

FIG. 2 is a front view of the weighing module of FIG. 1;

FIG. 3 is a rear view of the weighing module of FIG. 1;

FIG. 4 is a side view of the weighing module of FIG. 1;

FIG. 5 is a top view of the weighing module of FIG. 1;

FIG. 6 is a bottom view of the weighing module of FIG. 1; and

FIG. 7 is a perspective view of the weighing apparatus made up of a pair of weighing modules fitted on an idler assembly.

### DETAILED DESCRIPTION OF THE DRAWINGS

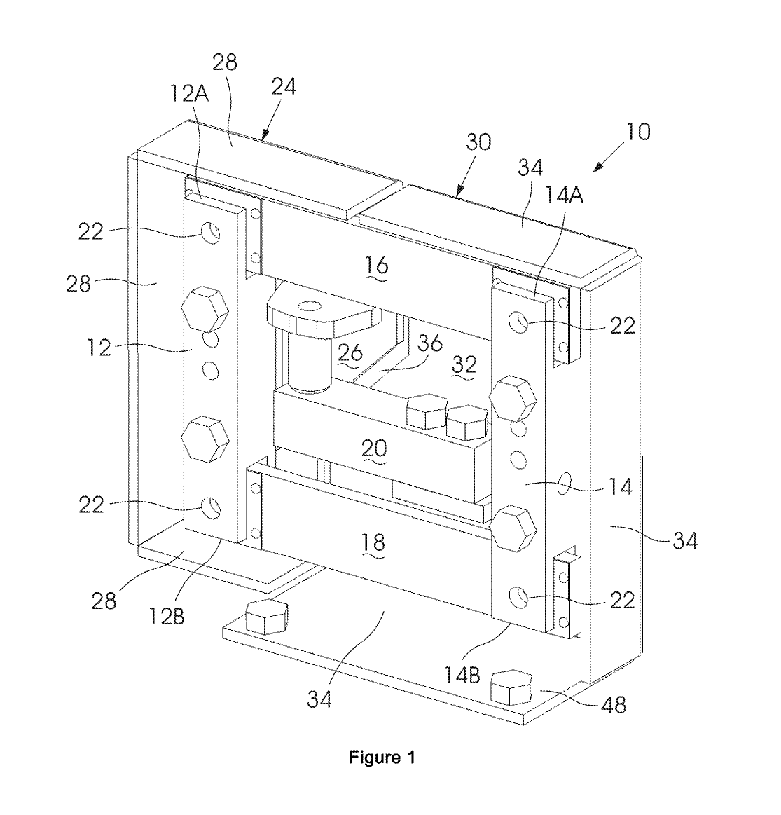

A weighing module according to a preferred embodiment of the invention is designated generally with reference numeral 10 in FIG. 1. The weighing module 10 comprises mountings 12,14, first and second bar members 16,18 extending between the mountings 12,14 and a load cell 20. Although the mountings 12,14 have been illustrated in the accompanying figures as common primary and secondary mounting members 12,14, each of the mountings may be separate and individual mountings.

The common primary mounting member 12 comprises fork-like mounting formations 12A,12B. Similarly, the common secondary mounting member 14 comprises fork-like mounting formations 14A,14B. The fork-like mounting formations 12A,12B,14A,14B are sized and shaped to receive respective ends of the bar members 16,18. The respective ends of the bar members 16,18 are pivotally captured in the respective fork-like mounting formations 12A,12B,14A,14B in mounting pins (not shown) passing through correspondingly aligned mounting apertures 22 defined in the common primary and secondary mounting members 12,14 and the bar members 16,18. In this configuration, the bar members 16,18 are retained in a spaced apart, parallel orientation with respect to each other.

Although the common primary and secondary mounting members 12,14 have been illustrated with fork-like mounting formations 12A,12B,14A,14B, it will be appreciated that in an alternative embodiment, the common primary and secondary mounting members 12,14 could comprise male mounting formations pivotally captured within fork-like formations on the opposing ends of the bar members 16,18. In either embodiment, it is preferable for the mounting pins to ride on bearings (not shown) mounted in the common primary and secondary mounting members 12,14 and/or the bar members 16,18

The common primary mounting member 12 is mounted on a primary mounting body in the form of a primary housing 24 having a base 26, sidewalls 28 and a cover member (not shown), the cover member being engagable with the sidewalls 28 to define, between the base 26, the sidewalls 28 and the cover member, an inner cavity for housing at least the common primary mounting member 12 and the respective ends of the bar members 16, 18.

The common secondary mounting member 14 is mounted on a primary mounting body in the form of a secondary housing 30 having a base 32, sidewalls 34 and a cover member (not shown), the cover member being engagable with the sidewalls 34 to define, between the base 32, the sidewalls 34 and the cover member, an inner cavity for housing at least the common secondary mounting member 14 and the respective ends of the bar members 16, 18. The bar members 16,18 space the primary and the secondary housings 24,30 from one another so as to define a gap 36 between there between, across which the load cell 20 is operative.

It will be appreciated that the weighing module 10 may be retrofitted directly to an object for the purposes of weighing the load applied to the object. Alternatively, a pair of weighing modules 10 may be fixed to one another to form a weighing apparatus 200 for weighing the load passing over a single idler assembly 300 on a conveyor belt assembly.

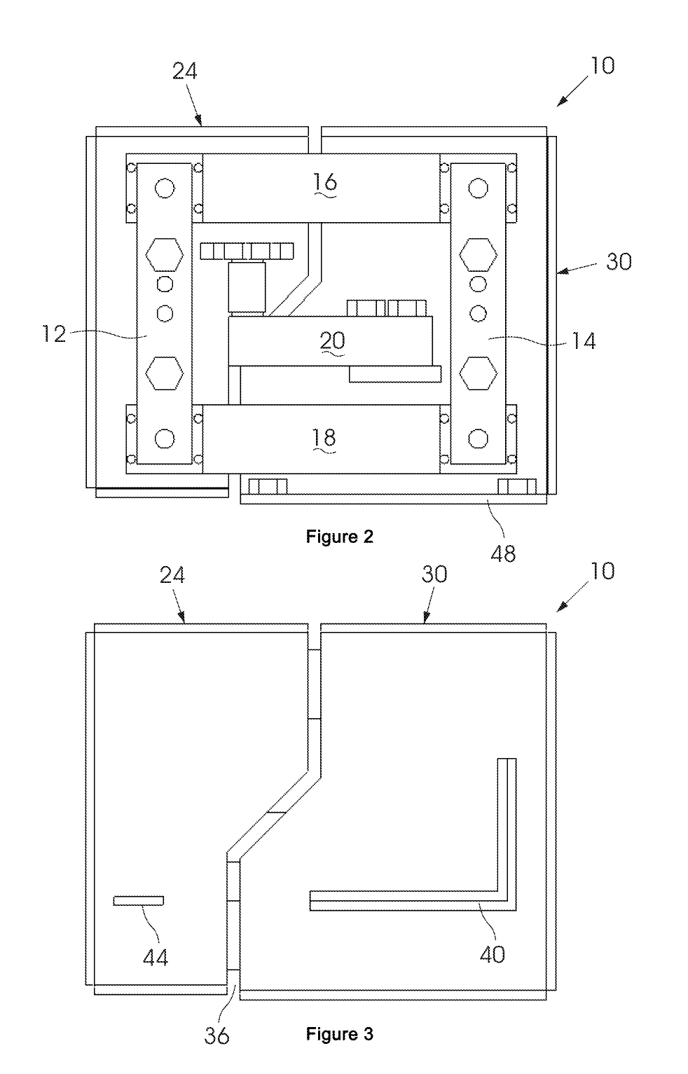

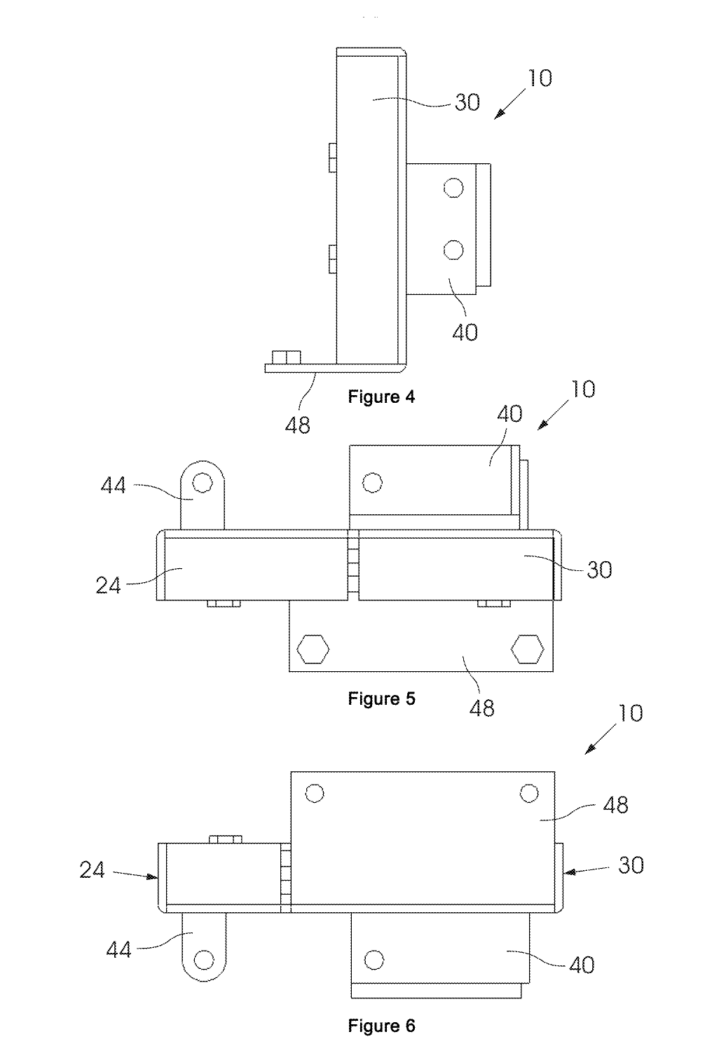

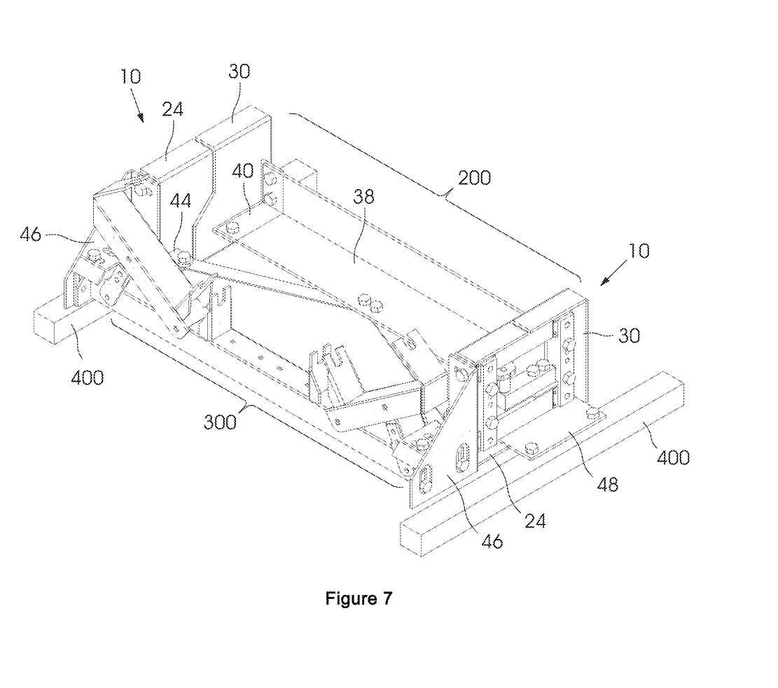

With reference now also to FIGS. 2 to 7, the weighing apparatus 200 is made up of a pair of weighing modules 10 fixed to one another across a cross member 38, fastened to cross member brackets 40 extending outwardly from the secondary housing 30 of each of the weighing modules 10. To further support the weighing modules 10, brace members 42 are secured between a brace support bracket 44 extending outwardly from the primary housing 30 of each of the weighing modules 10 and the cross member 38.

Extending outwardly from each of the primary housings 24 are idler assembly support brackets 46 onto which an idler assembly 300 is supportable. It will be appreciated that the weighing apparatus 200 may be retrofitted to an existing idler assembly on a conveyor belt assembly or purpose built onto an idler assembly, mountable to runners 400 of the conveyor belt assembly on mounting brackets 48 extending outwardly from the secondary housings 30 of each of the weighing modules 10.

In use, the bar members 16,18 and mountings 12,14 co-operate with one another to substantially nullify any force component acting in a plane coplanar or substantially parallel to a plane in which the bar members 16,18 lie, thereby to enable the load cell 20 to measure substantially only a strain caused by the weight of a load on the idler assembly 300 (or other object).

Although the invention has been described above with reference to preferred embodiments, it will be appreciated that many modifications or variations of the invention are possible without departing from the spirit or scope of the invention.

For example, it will be appreciated that the mounting pins could be affixed directly to primary and secondary housings 24,30, with the bar members 16,18 pivotally mounted thereon. However, the direct mounting of the mounting pins 22 to the primary and secondary housings 24,30 is a contributing factor to the possible inaccuracy of the weighing module 10.

As a result, it has been found that the accuracy of the weighing module 10 can be increased by pivotally mounting the bar members 16,18 on mounting pins passing through correspondingly aligned mounting apertures 22 in the bar members 16,18 and precision manufactured common mounting members 12,14 being fixed to the primary and secondary housings 24,30. Under this new method of manufacturing the weighing module 10, the mounting pins float in a spaced apart relationship relative to the primary and secondary housings 24,30. It will be appreciated further that the bearings on which the mounting pins ride, further increase the accuracy of the weighing module 10.

1. A weighing module for weighing a load applied to an object, the weighing module including:
at least one first mounting and at least one second mounting being attachable to a primary part of the object such that the first and the second mountings are spaced apart from one another;
at least one third mounting and at least one fourth mounting being attachable to a secondary part of the object such that the third and the fourth mountings are spaced apart from one another;
at least a first bar member having a first end for pivotally mounting to the first mounting and an opposing second end for pivotally mounting to the third mounting;
at least a second bar member having a first end for pivotally mounting to the second mounting and an opposing second end for pivotally mounting to the fourth mounting, each end of the bar members being pivotally mounted on the mounting by a mounting pin passing through correspondingly aligned mounting apertures defined in the respective end of the bar members and the respective mounting so as to retain the first bar and the second bar in a spaced apart and parallel orientation relative to one another; and
one or more load cells attachable between the one or more mountings attachable to the primary part of the object and the one or more mountings attachable to the secondary part of the object
such that in use and under load, the bar members and mountings co-operate with one another to substantially nullify any force component acting in a plane coplanar or substantially parallel to a plane in which the bar members lie, thereby to enable the load cell to measure substantially only a strain caused by the weight of the load on the object.

2. A weighing module according to claim 1, wherein each of the mountings is a fork-like mounting formation for receiving the respective end of the respective bar member, the mounting pin pivotally capturing the end of the bar member within the fork-like mounting formation.

3. A weighing module according to claim 1, wherein each of the mountings comprise a male mounting formation and each of the ends of the bar members are fork-like formations for receiving the male mounting formation therein, the mounting pin pivotally capturing the male mounting formation of the mounting within the fork-like mounting formation of the bar members.

4. A weighing module according to claim 1, wherein the first and second mountings are opposing ends of a common primary mounting member, the common primary mounting member being attachable to the primary part of the object.

5. A weighing module according to claim 4, wherein the third and the fourth mountings are opposing ends of a common secondary mounting member, the common secondary mounting member being attachable to the secondary part of the object.

6. A weighing module according to claim 5, wherein the mounting pins ride on bearings mounted in the mountings, in the ends of the bar members or in both.

7. A weighing module according to claim 6, wherein the common primary mounting member is mounted to a primary mounting body and the common secondary mounting member is mounted to a secondary mounting body, the primary and the secondary mounting bodies being attachable to the primary and secondary parts of the object respectively.

8. A weighing module according to claim 7, wherein the primary and the secondary mounting bodies are primary and secondary housings for housing the common primary and secondary mounting members respectively, the primary and the secondary housings being spaced apart from one another by the bar members extending there between, so as to define a gap between the primary and the secondary housings.

9. A weighing module according to claim 8, wherein the one or more load cells are connected between the primary and secondary housings across the gap defined therebetween.

10. A weighing module according to claim 9, wherein the each of the primary and the secondary housings include a base member and a cover member, the base member comprising a base with sidewalls extending outwardly there from, the cover member being engagable with the sidewalls to define, between the base, the sidewalls and the cover member, an inner cavity for housing the common mounting members and respective ends of the bar members mounted thereto.

11. A weighing module according to claim 10, wherein the object is a conveyor belt assembly, the primary part of the object being an idler assembly and the secondary part of the object being a runner structure running between the multiple idler assemblies on the conveyor belt assembly.

12. A weighing module according to claim 11, wherein the primary housing is attachable to the primary part of the object and the secondary housing is attachable to the secondary part of the object, the primary and the secondary housings being attachable to the object by fasteners.

13. A weighing module according to claim 12, wherein the fasteners are nuts and bolts.

14. A weighing apparatus including a pair of weighing modules in accordance with claim 11, the secondary housings of the weighing modules being connected to each other on opposing ends of a cross member, such that the primary housings of each of the weighing modules are attachable to opposing ends of the idler assembly and the secondary housings of each of the weighing modules are attachable to opposing sides of the runner structure of the conveyor belt assembly.

15. An idler assembly for weighing a load passing there over including:
a support bracket for supporting one or more idler mounting sub-brackets on which idlers are supportable;
a pair of weighing modules in accordance with any one of claims 11 to 13, the primary housings of each of the weighing modules being attached to opposing ends of the support bracket; and
a cross member attached at each opposing end to the secondary housings of the weighing apparatus, the secondary housings being attachable to opposing sides of a runner structure of a conveyor belt assembly.

16-18. (canceled)
